(19) United States
(12) Patent Application Publication
(10) Pub. No.: US 2005/0177411 A1
(43) Pub. Date: Aug. 11, 2005

(54) System and method for managing demand influencing factors

(76) Inventor: Wolfgang Schuhn, Saarbruecken (DE)

Correspondence Address: KENYON & KENYON, 1 BROADWAY, NEW YORK, NY, 10004, US

(21) Appl. No.: 10/739,133

(22) Filed: Dec. 19, 2003

(51) Int. Cl. G06F 17/60

(52) U.S. Cl. 705/10; 705/14

(57) ABSTRACT

A method and system for managing demand influencing factors. According to one embodiment, a demand influencing factors module displays through a user interface data representing occurrences of demand influencing factors for use in a forecast calculation, receives through the user interface an instruction to modify one or more of the demand influencing factor occurrences, and applies the instructed modification to the data.

### BACKGROUND OF THE INVENTION

Efficient supply chain management includes two main goals:
avoid stock out situations, which lead to lost sales and can have more general, negative side effects (like losing customers), and
avoid over stock situations, which lead to unnecessarily high inventory costs (mainly stock keeping and capital tie-up).

These goals imply the need for a replenishment process that creates optimized order quantities. To achieve this goal, a quite accurate knowledge of the future demand (e.g., of the sales of a product in a store or the consumption of a product in a distribution center) is needed. This is normally produced by forecasting algorithms. Such forecasting algorithms calculate future demand figures based on historical demand data.

Generally, three factors provide the most impact to the quality of a demand forecast:
high quality of the historical data on which the forecast is based,
selection of the most appropriate forecast model/method and set of parameters that describe the demand characteristic of a specific product, and
the effect (past and future) of external influences on the demand.

With respect to this third factor, there are generally two different approaches to include knowledge about future events in demand forecasting calculation:
correction factors (lift factors) that are applied to the forecast result (and to the historical data prior to the forecast). This implies that the knowledge about the effect of the external demand influences is outside of the forecasting system and will be entered by a user. Such correction factors often are maintained as profiles for particular events or for complete seasonal cycles. They are normally assigned on a higher hierarchical level, such as product group. The maintenance of these profiles is time consuming and depends upon assumptions of the user. Marrying the various profiles such as seasonal profiles with promotion lifts is also based on assumptions. Often the forecast is not meaningful because seasons and promotions interact.
causal analysis that calculates the influence of a given history of external factors along with a historical demand time series. By doing this, it is possible to explain the pattern of a time series (partly) by external factors and to apply this ‘knowledge’ to the forecasted demand to derive the total demand. With this approach, not the effect of the external demand influences (as with correction factors), but only the occurrence or value of the external demand influences itself is used as input to the forecast.
   The causal based forecasting is generally considered the more sophisticated approach, since it provides the best results with the least user interaction; however, in some situations the use of correction factors might be desirable, such as when an external demand influence occurs for the first time (or so sporadically that it can be considered a one-time occurrence), and thus there is no available historical data for this factor that could be used to estimate the effect in a causal based forecasting approach.

Thus, one of the major factors for providing a high quality and meaningful demand forecast is the input of external demand influences into a forecasting system. The management of this external demand influence information and its integration into the replenishment process determine the ultimate efficiency of supply chain management.

Accordingly, there is a need in the art for a system and method that optimally manages external influences that have a significant effect on demand (i.e., demand influencing factors).

### SUMMARY OF THE INVENTION

Embodiments of the present invention provide for managing demand influencing factors. According to one embodiment, a demand influencing factors module displays through a user interface data representing occurrences of demand influencing factors for use in a forecast calculation, receives through the user interface an instruction to modify one or more of the demand influencing factor occurrences, and applies the instructed modification to the data.

A demand influencing factors module of the present invention provides the data management for demand influencing factors to be used in a forecast, coupled with a user interface for efficient maintenance and reviewing of the factors. The demand influencing factor data may be imported from external systems and input to a forecasting engine to allow a demand forecast to take into account the effect of predictable external factors on the demand.

### BRIEF DESCRIPTION OF THE DRAWINGS

FIG. 1 is a flow chart that depicts a process for managing demand influencing factors in accordance with an embodiment of the present invention.

FIG. 2 is a block diagram that depicts the data flow of demand influencing factors in accordance with an embodiment of the present invention.

FIG. 3 is a block diagram that depicts a user computing device in accordance with an embodiment of the present invention.

FIG. 4 is a block diagram that depicts a system architecture for managing demand influencing factors in accordance with an embodiment of the present invention.

FIG. 5 is a screen shot that depicts a demand influencing factor workbench in accordance with an embodiment of the present invention.

FIG. 6 is a screen shot that depicts a selection screen in accordance with an embodiment of the present invention.

FIG. 7 is a screen shot that depicts another selection screen in accordance with an embodiment of the present invention.

FIG. 8 is a screen shot that depicts a demand influencing factor tree in accordance with an embodiment of the present invention.

FIG. 9 is a screen shot that depicts a configuration screen for a demand influencing factor tree in accordance with an embodiment of the present invention.

FIG. 10 is a screen shot that depicts different views of a demand influencing factor tree in accordance with an embodiment of the present invention.

FIG. 11 is a screen shot that depicts changing of demand influencing factor occurrences in accordance with an embodiment of the present invention.

FIG. 12 is a screen shot that depicts details of a demand influencing factor occurrence change in accordance with an embodiment of the present invention.

FIG. 13 is a screen shot that depicts administration of a demand influencing factor occurrence change in accordance with an embodiment of the present invention.

FIG. 14 is a screen shot that depicts memorandum of a demand influencing factor occurrence change in accordance with an embodiment of the present invention.

FIG. 15 is a screen shot that depicts assignment selection of a demand influencing factor occurrence change in accordance with an embodiment of the present invention.

FIG. 16 is a screen shot that depicts an assignment list of a demand influencing factor occurrence change in accordance with an embodiment of the present invention.

FIG. 17 is a screen shot that depicts a demand influencing factor calendar in accordance with an embodiment of the present invention.

### DETAILED DESCRIPTION

### Demand Influencing Factors

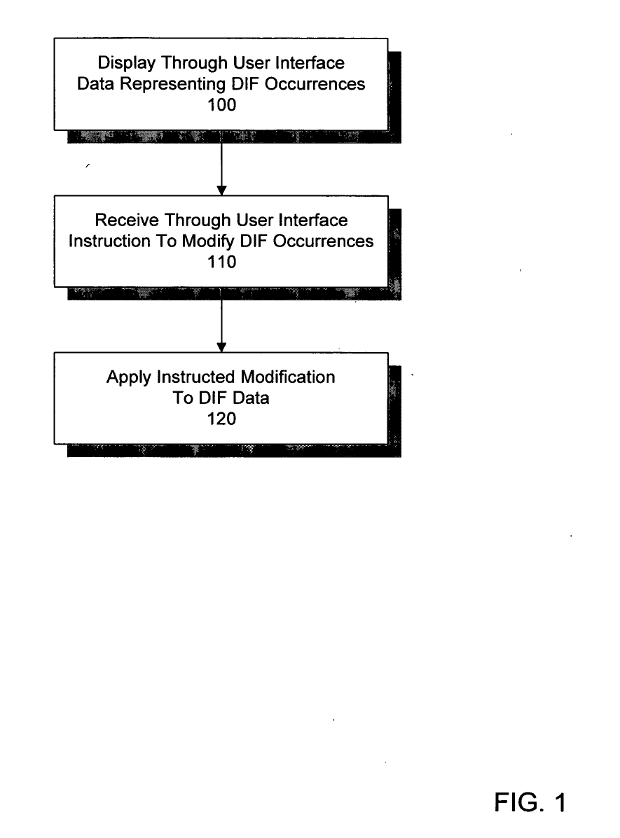

FIG. 1 depicts a process for managing demand influencing factors (“DIF”) in accordance with an embodiment of the present invention. A DIF module displays through a user interface data representing DIF occurrences for use in a forecast calculation (step 100), receives through the user interface an instruction to modify one or more of the DIF occurrences (step 110), and applies the instructed modification to the data (step 130).

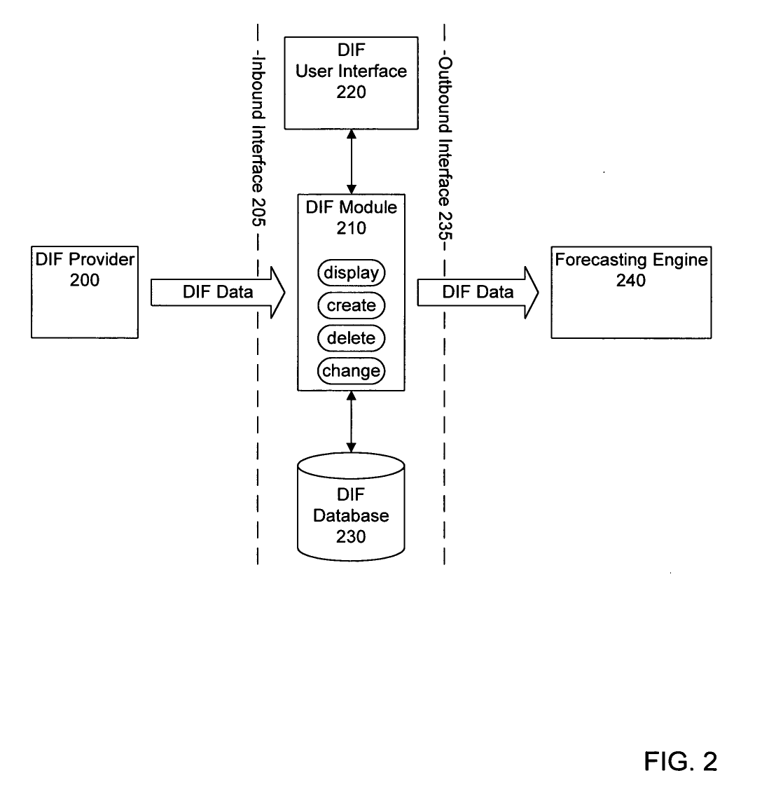

As shown in FIG. 2, DIF data may be received by DIF module 210 from DIF provider 200 through inbound interface 205. DIF module 210 may store the DIF data in a data store such as DIF database 230, and the DIF data may be displayed, created, deleted or changed by a user through DIF user interface 220. When the DIF data is ready to be included in a forecast, DIF module 210 sends the DIF data to forecasting engine 240 through outbound interface 235.

In one embodiment, DIF provider 200 may include promotion management (e.g., SAP R/3 Retail) or planning software components, and forecasting engine 240 may include third party software that uses algorithms that take into account external demand influencing factors (i.e., DIF data) that help to explain the original time series that is forecasted. General forecasting techniques include models based on Box-Jenkins, Weighted ARX, Regression Analysis, Dynamic Linear Models (DLM's/Kalman Filter), and Exponential Smoothing Techniques.

Through the use of a data model and user interface for all different kinds of factors with significant effect on the demand of a product, DIF module 210 allows users/customers to define through DIF user interface 220 the factors that are most important for their businesses, import data for those factors from external systems or locally, and maintain and visualize all occurrences of those factors in a concise and comprehensible way. The occurrences of these factors can be assigned to locations (stores, distribution centers (“DC”s)) and products (items) as needed, while allowing generic assignment techniques for better handling.

Examples of DIFs are:
promotions and advertising campaigns,
public holidays or vacation (e.g. Easter, Thanksgiving, Christmas, back to school),
sports events (e.g. Super Bowl, Soccer World Championship),
sales prices and price changes,
exceptional weather conditions (e.g. heat wave, hurricane, etc.), and
other factors that can be quantified, maintained and electronically stored and used for explaining the sales or demand of a product (e.g. the aggregated store sales, the total sales area/shelf facing of the stores influences the DC demand as does the number of stores that a DC is supplying; the expected attendance rate of a location influences the store demand).
   These DIFs may be considered “regular” DIFs, in that the effect of these DIFs on the future demand may be calculated automatically by a forecast engine. DIFs that may be used to influence a forecast result outside of a forecast engine may be considered “correctional” DIFs: “ignore” DIFs, which may be used to exclude historic consumption values from a forecast calculation, and “correction factors”, which may be used to alter the result of a forecast calculation.

The following characteristics concern the evolution of a DIF over time:
event like DIF: external events that are limited to a coherent and usually short time interval; i.e., they have discrete occurrences. Examples are promotions, advertising campaigns or any calendar related events, like public holidays or vacations. The occurrences can be either simply Boolean (i.e., something occurs or doesn't occur, like a public holiday) or they can have a certain intensity or value (e.g., hurricanes or heat waves). These types of DIFs are generally valid for a larger selection of locations and products and sometimes are not product specific,
slow changing DIF: factors with a particular value at any time that changes only occasionally; for example, the sales price of a product. Such DIFs are generally valid for only one single location and product, and
fast changing DIF: virtual continuously changing factors that can be described rather by a time series than by single, occasional occurrences or changes of a DIF; for example, the aggregated store forecasts as predictor for the DC forecast.

In accordance with an embodiment of the present invention, DIF module 210 may manage DIFs with two basic objects: one to define DIFs, and one to define the occurrence of each DIF. Some basic information for a DIF object may be:
unique identifier (ID)
language dependent description (short text)
type: determines the basic character of the DIF and controls what values and validity periods are allowed:
   Boolean: the DIF has discrete occurrences without a value (e.g., promotions)
   value: the DIF has discrete occurrences with a value (e.g., heat periods); the gaps between the different occurrences are implicitly regarded to have a value of zero
   metric: the DIF has a particular value at any point of time; the value of an occurrence is valid until the starting point of the next occurrence (e.g., for prices)
   sales price: the DIF uses sales price information (thereby, it is a metric DIF)
   time series: the DIF uses values stored in a time series (e.g., aggregated store forecasts as DIF for the DC forecast (thereby, it is a metric DIF); another parameter of the DIF definition may allow specifying the time series to be used (type of the time series)
   correction factor: occurrences are used to correct forecasted demand values by manually given factors (e.g., for first-time or one-time occurrences of a regular DIF)
   ignore: occurrences are used to exclude historical demand periods from forecasting; average historical demand values may be used instead (e.g., in case of unforeseen events that distort the consumption figures)
level of assignment: occurrences of the DIF may be either assigned to locations only, location group or to products within a location

DIF occurrence objects may contain information about the occurrences and values of the defined DIFs and the locations and products for which they are valid. Some basic information for a DIF occurrence object may be:
unique identifier (number)
language dependent description (short text)
validity period: time interval specified by a valid-from and valid-to date; for metric DIF, only the valid-from date may be maintained as they are valid until the starting date of the subsequent occurrence
recurring indicator: the DIF occurrence recurs every year at the same time; this may be set for those DIFs with discrete occurrences
value: a value may be given for DIFs of type metric, value and correction factor; for sales price and time series DIF, the actual values are given by the time-dependent sales prices or time series periods
activity indicator: controls whether or not the occurrence is used in the forecast calculation (active/not active)
reference field: for linking a DIF occurrence to another object for informational reasons (e.g., to an external promotion number) or interface reasons
memo: language independent long text that may be stored with a DIF occurrence
administration information: the mode the occurrence was created in (automatically via inbound interface or manually via user interface) and the user ID and time stamp of initial creation and last change of the DIF occurrence

As mentioned above, for every DIF occurrence the information for which locations and products the occurrence is valid may be stored. It depends on the definition of the DIF, on which level this assignment is possible:
assignment on location level only: the DIF occurrence can be valid for all locations or a selection of locations; it is valid for all products within one location. This makes sense for most calendar related events that are not bound to specific products (e.g., holidays, vacation, etc.)
assignment on location group level: the DIF occurrence can be valid for all locations that belong to an assigned group.
assignment on location and product level: the DIF occurrence can be valid for all locations or a selection of locations and a selection of products within every location. This makes sense for product related factors like prices or promotions.

If a DIF occurrence is valid for all products within a location, a location group or for all locations, this may be achieved by generic assignment instead of assigning the occurrence to each individual location or product. This implies that a DIF occurrence is valid for new locations, location groups or products that are created after the creation of the DIF occurrence, as well.

DIF user interface 220 may provide the following features:
visualization: provide structured and easily accessible information about all DIFs and their occurrences; this is to answer user questions such as:
   what DIFs are available and what occurrences are maintained for the individual DIFs?
   what locations and/or products is a particular DIF occurrence valid for?
   what DIFs and DIF occurrences exist for a particular location and/or product?
   what are the values of particular DIFs (assigned to particular locations and/or products) over a specific period of time?
display DIF occurrences: give the user all information about a particular DIF occurrence (attributes and assignment to locations and products)
create new DIF occurrences: includes giving values for all attributes of a DIF and to assign the locations and products for which the DIF occurrence is valid; also possible to create new occurrences with reference to existing ones (copy function)
change any attribute of DIF occurrence or change the assignment of the DIF occurrence to locations and products
delete an entire DIF occurrence: including all attributes and the assignment to locations and products

### Architecture

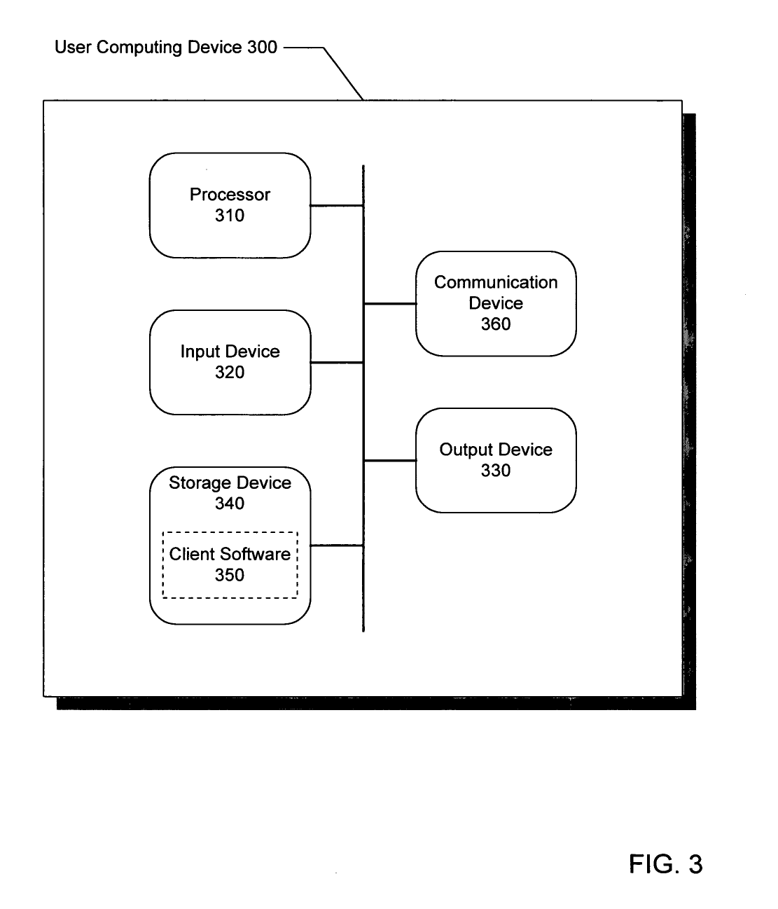

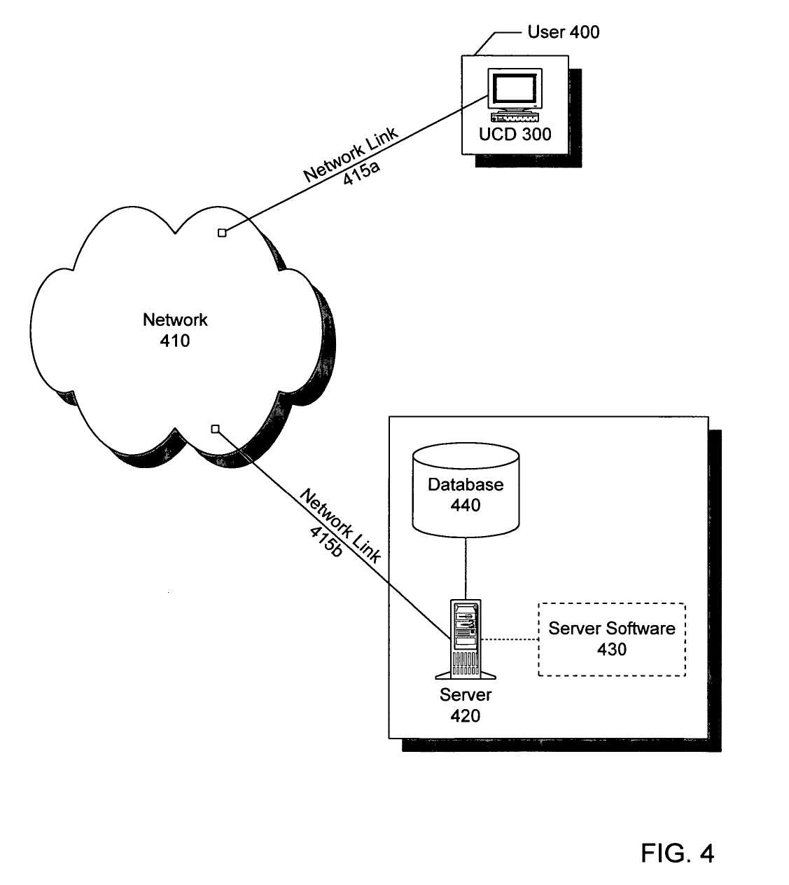

FIGS. 3 and 4 illustrate the components of a basic computer and network architecture in accordance with an embodiment of the present invention. FIG. 3 depicts user computing device 300, which may be a personal computer, workstation, handheld personal digital assistant (“PDA”), or any other type of microprocessor-based device. User computing device 300 may include a processor 310, input device 320, output device 330, storage device 340, client software 350, and communication device 360.

Input device 320 may include a keyboard, mouse, pen-operated touch screen or monitor, voice-recognition device, or any other device that accepts input. Output device 330 may include a monitor, printer, disk drive, speakers, or any other device that provides output.

Storage device 340 may include volatile and nonvolatile data storage, including one or more electrical, magnetic or optical memories such as a RAM, cache, hard drive, CD-ROM drive, tape drive or removable storage disk. Communication device 360 may include a modem, network interface card, or any other device capable of transmitting and receiving signals over a network. The components of user computing device 300 may be connected via an electrical bus or wirelessly.

Client software 350 may be stored in storage device 340 and executed by processor 310, and may include, for example, the client side of a client/server application such as SAP SCM 4.1 that embodies the functionality of the present invention (including, e.g., DIF module 210 and DIF user interface 220).

FIG. 4 illustrates a network architecture in accordance with an embodiment of the present invention. According to one particular embodiment, when user 400 invokes an SAP SCM application, client software 350 of user computing device 300 communicates with server software 430 (e.g., the server side of the SAP SCM application) of server 420 via network link 415a, network 410, and network link 415b.

Network links 415 may include telephone lines, DSL, cable networks, T1 or T3 lines, wireless network connections, or any other arrangement that implements the transmission and reception of network signals. Network 410 may include any type of interconnected communication system, and may implement any communications protocol, which may secured by any security protocol.

Server 420 includes a processor and memory for executing program instructions as well as a network interface, and may include a collection of servers. In one particular embodiment, server 420 may include a combination of enterprise servers such as an application server and a database server. Database 440 (including, e.g., DIF database 230) may represent a relational or object database, and may be accessed via a database server.

User computing device 300 and server 420 may implement any operating system, such as Windows or UNIX. Client software 350 and server software 430 may be written in any programming language, such as ABAP, C, C++, Java or Visual Basic.

### User Interface

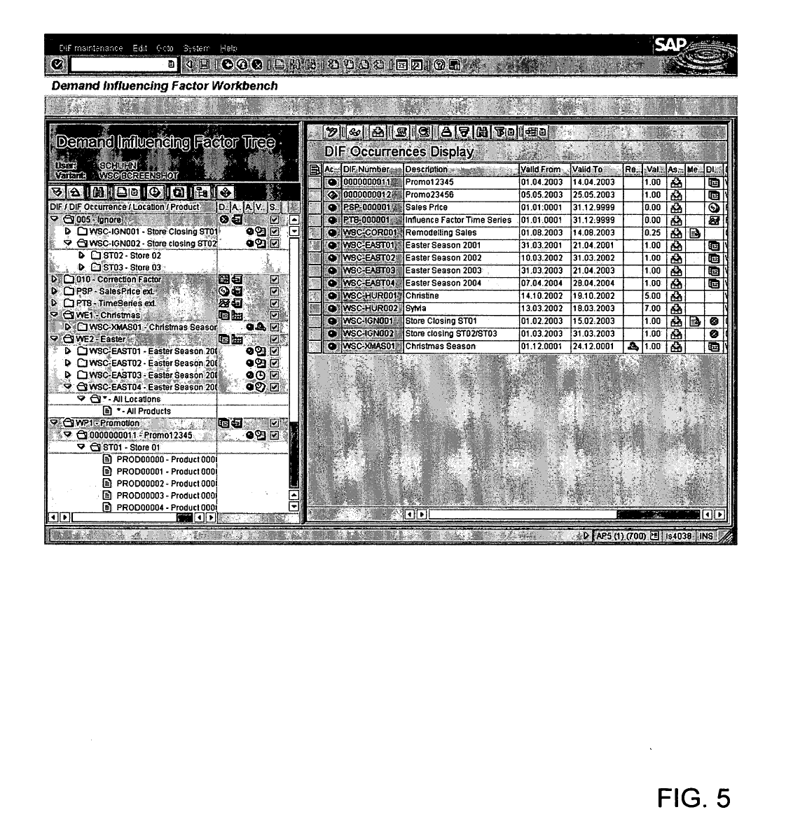

FIGS. 5-17 illustrate screens of DIF user interface 220 in accordance with an embodiment of the present invention. FIG. 5 depicts a general layout of a DIF workbench, which provides for the visualization of DIF data along with maintenance functions for creating, changing and deleting DIF occurrences and their assignments to locations and/or products. Some additional features such as user specific configuration, sorting and searching of data are provided to enhance the usability of the workbench. The DIF workbench provides all the features and functions for a consistent user dialog for managing all DIF data; it provides a tree display as an overview of the data objects on the left-hand side of the screen and a more detailed list display of the data that has been selected from the tree on the right-hand side. Additional display and maintenance functions can be reached from the tree or the list display. Also, the right-hand side of the workbench may hold an exceptions subscreen which displays messages about DIF exception situations that have occurred in any of the processes dealing with DIF data (e.g., inbound interface, forecast calculation, etc.).

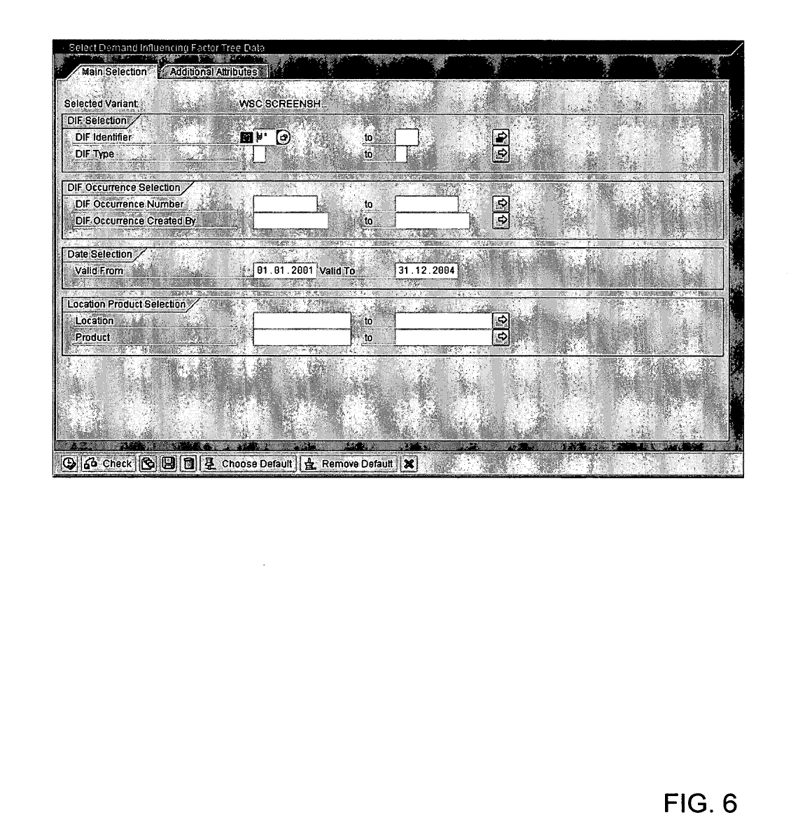

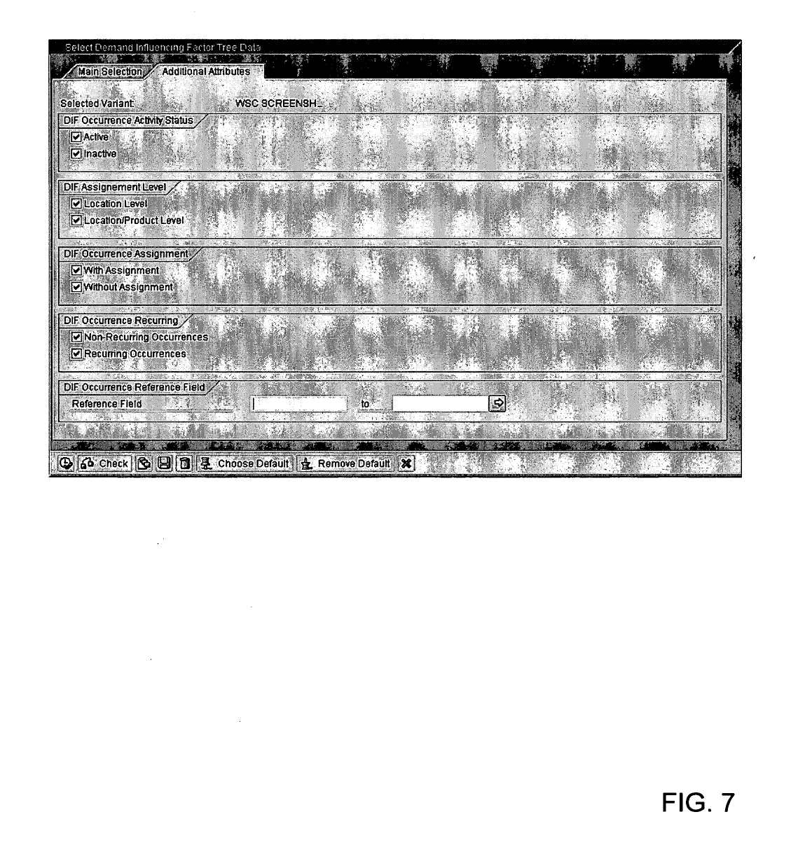

Before a user enters the main workbench screen of FIG. 5, the selection screens of FIGS. 6-7 appear, allowing the user to select the content to be displayed in the navigation tree (the “Demand Influencing Factor Tree” section on the left-hand side of the workbench in FIG. 5). FIG. 6 shows the “Main Selection” view, which allows the user to select content for display by DIF, DIF occurrence, validity period or product/location. FIG. 7 shows the “Additional Attributes” view, which allows the user to select content for display by activity status, assignment level, assignment status, recurring status, or reference.

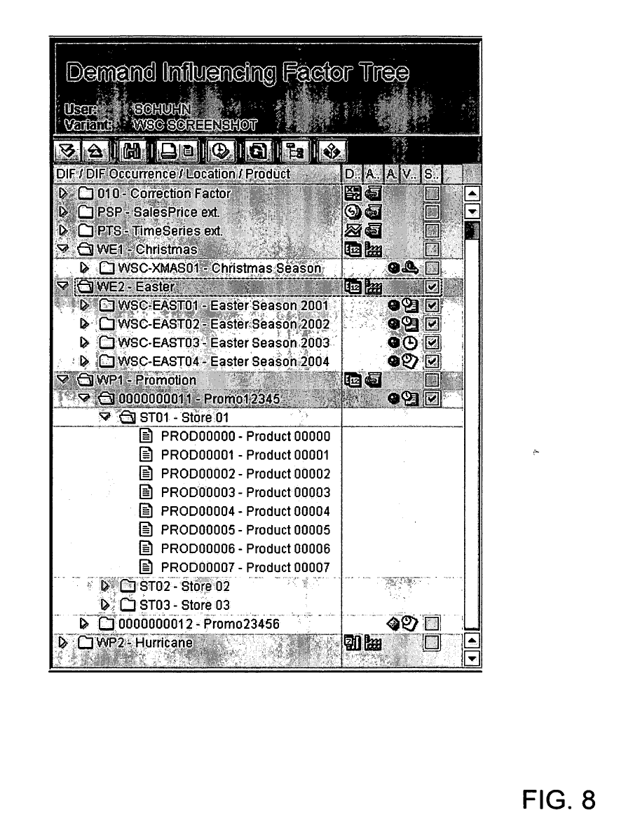

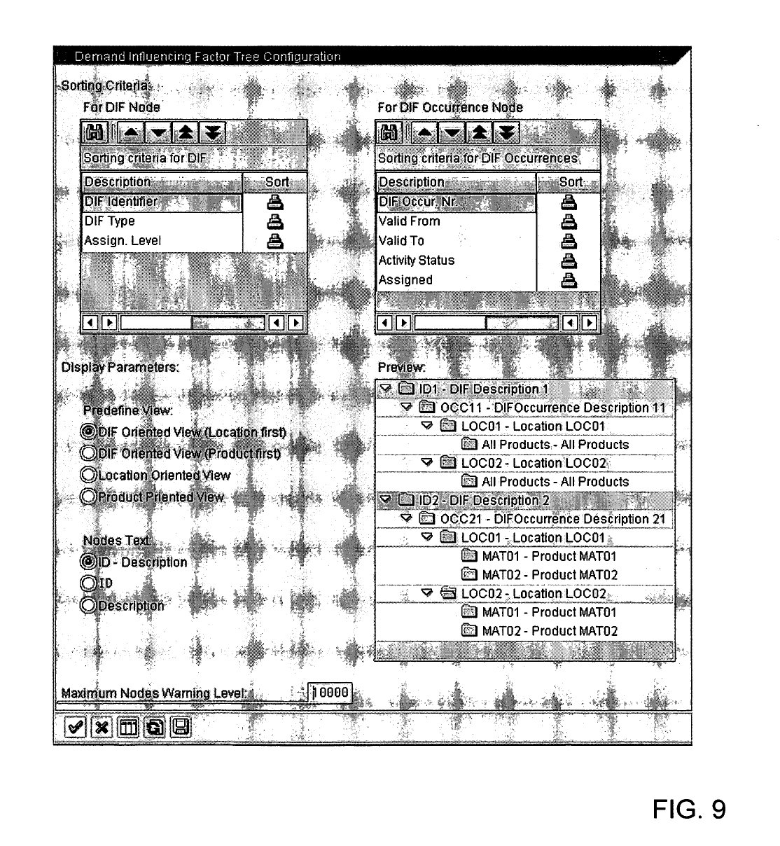

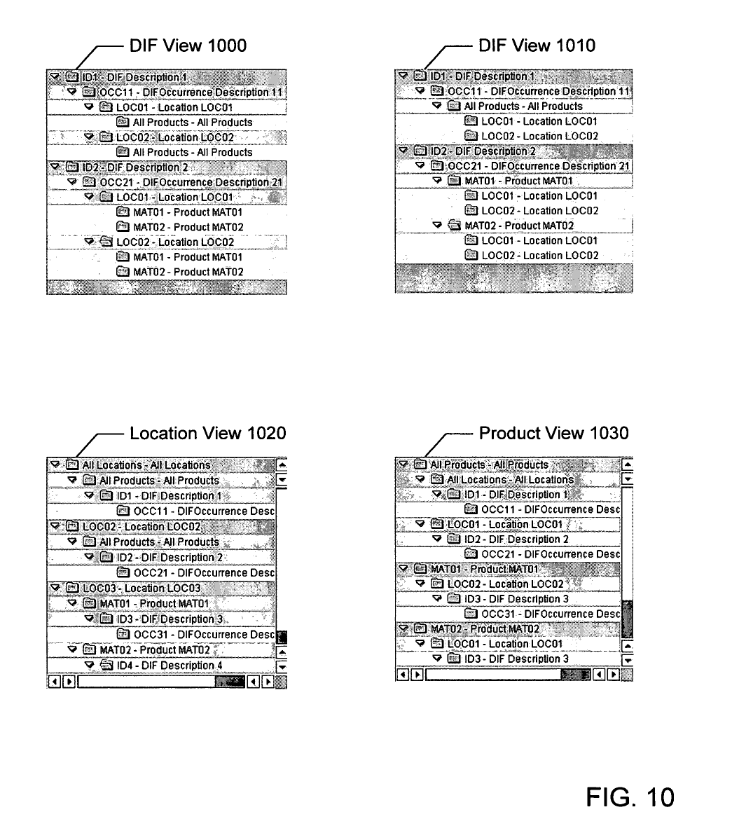

FIG. 8 shows the DIF navigation tree, while FIGS. 9-10 show the configuration options and different available views for the navigation tree, respectively. As seen in FIG. 8, the DIF navigation tree displays DIFs, DIF occurrences and their assignment to locations and products. The following node levels are available in the tree:
DIF
DIF occurrence
Location
Product
   In case of generic DIF assignment, an “All Locations” or “All Products” node may be displayed for location and product.

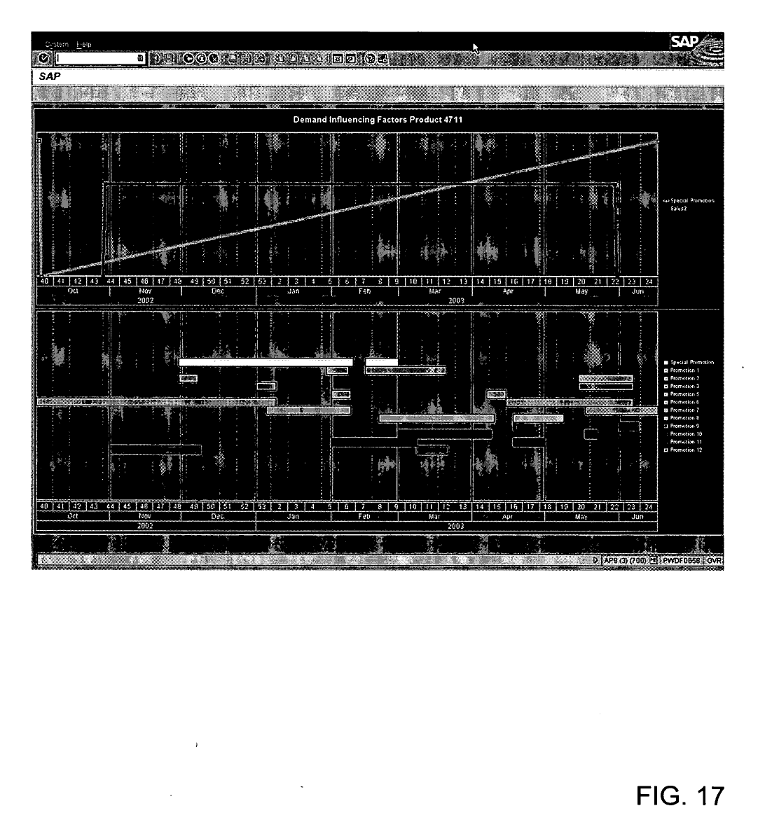

The following attributes of DIF and DIF occurrences are visualized in the tree for each DIF or DIF occurrence node by different icons:
DIF
   type: Boolean, value, metric, sales price, time series, correction factor, ignore
   assignment level: location, product
DIF occurrences
   activity status: active, not active or active without assignment
   validity period related to the current date: past, present, future or recurring DIF occurrence
   assignment status: occurrence is assigned or not assigned to any locations/products
      The tree provides not only an overview of the existing DIF occurrences and their assignment, but serves also as a selection tool for the occurrence list (right-hand side of workbench in FIG. 5) and the DIF calendar (FIG. 17).

As FIG. 9 shows, the user can choose the sorting of nodes within one node level for DIF and DIF occurrences; the user may also define the order of sorting criteria within one node level and choose for each sorting criterion between ascending or descending sorting. FIG. 10 shows examples of the predefined views that may be selected. For example, DIF view 1000 represents the first predefined view in the configuration screen of FIG. 9, which displays DIF occurrences by DIF and assigned locations and products by DIF occurrence. DIF view 1010 represents the second predefined view, which displays DIF occurrences by DIF and assigned products and locations by DIF occurrence. Location view 1020 represents the third predefined view, which displays DIF occurrences by location (and product), and product view 1030 represents the fourth predefined view, which displays DIF occurrences by product (and location).

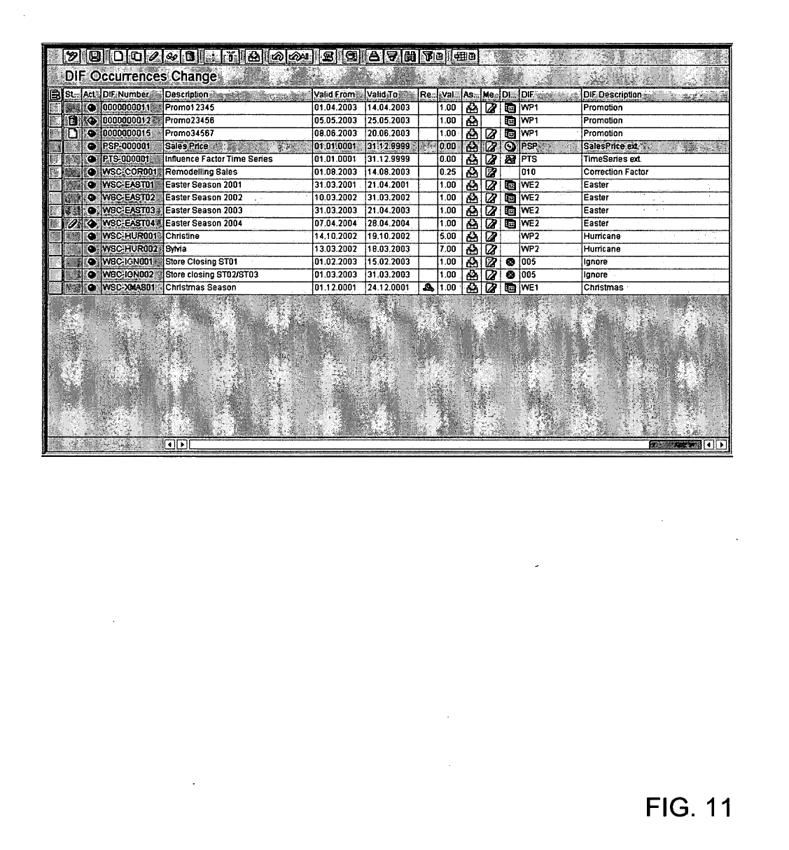

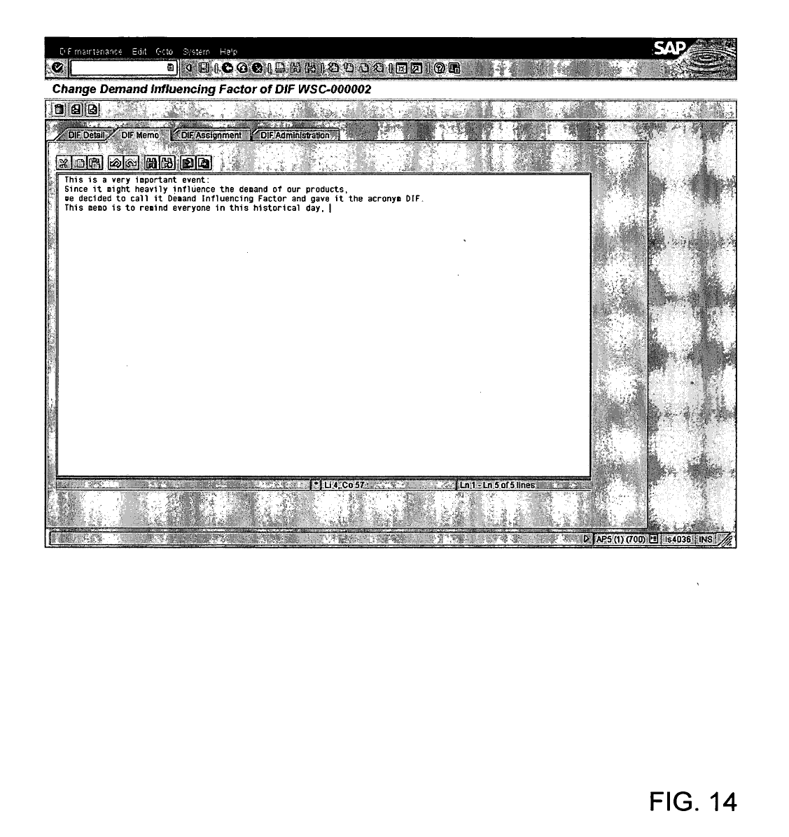

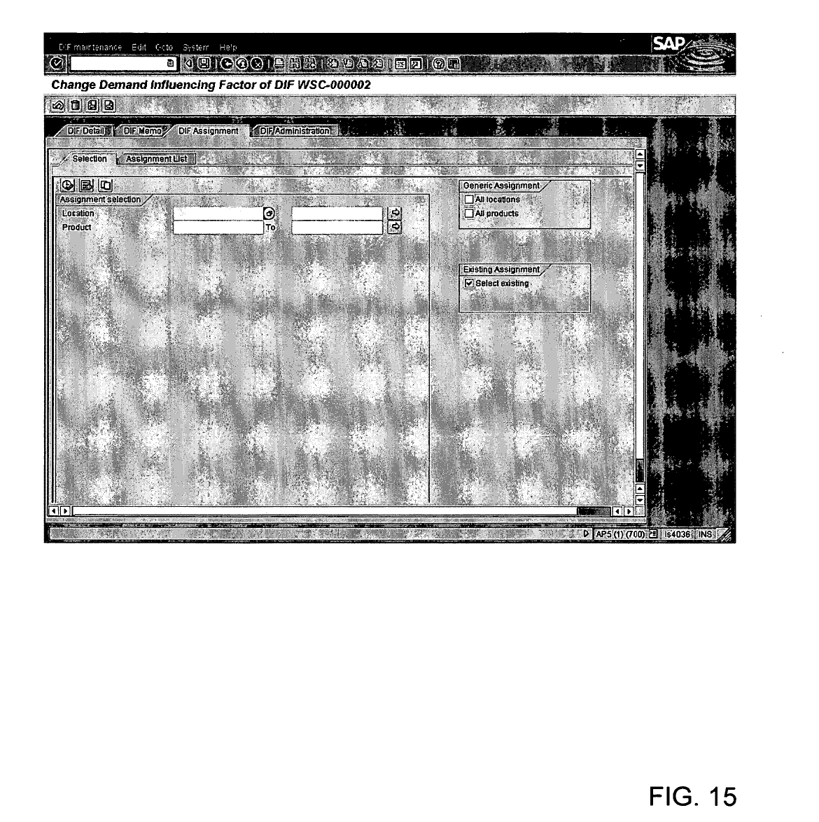

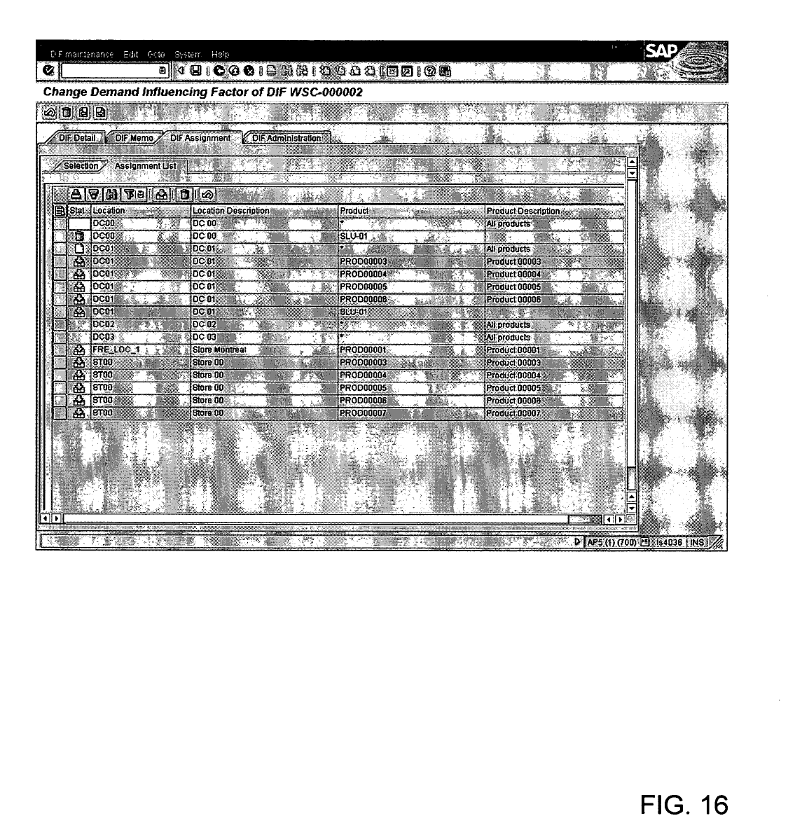

FIG. 11 shows the change mode of the occurrence list, which is identical to the right-hand side of workbench in FIG. 5 except for the addition of the left-most column, which indicates the current change status of a DIF occurrence by different icons. The following attributes are visualized by column (left-to-right) in the DIF occurrence change list of FIG. 11:
current change status of DIF occurrence: different icons may represent unchanged (as currently stored in data store), changed, created or deleted
activity status (same icons as navigation tree): the user can click on the icon to change the activity status
DIF occurrence number and language dependent short text
validity period (valid from and valid to date)
recurring indicator
value (for Boolean DIF, value ‘1’ is displayed)
assignment status (whether or not a DIF occurrence is assigned to any locations and products, displayed as an icon): the user can click on this icon to branch to the assignment function for one single DIF occurrence (FIGS. 15-16)
icon that represents a verbal memo that can be maintained with a DIF occurrence: the user can click on this icon to branch to the display/maintenance of the memo text (FIG. 14)
DIF type (same icons as in navigation tree)
identifier of the DIF (DIF definition) and language dependent short text

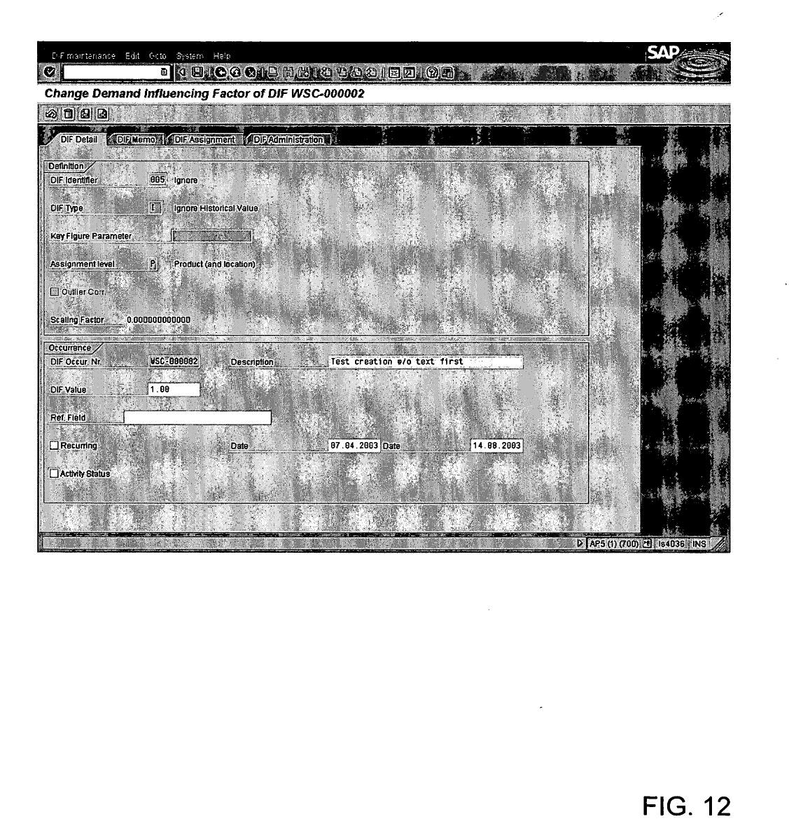

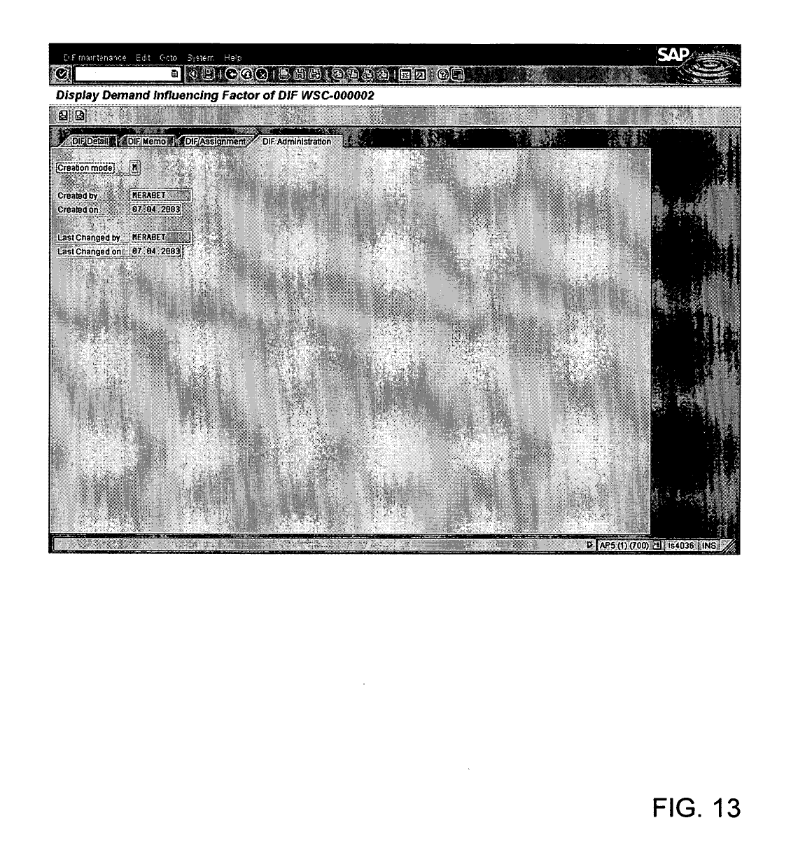

FIGS. 12-16 illustrate further screens that allow the user to view a DIF occurrence and change a DIF occurrence and/or its assignment. FIG. 12 shows a DIF Detail view, which includes all the DIF occurrence attributes for modification. FIG. 13 shows a DIF Administration view, which provides change administration information. FIG. 14 shows a DIF Memo view, which allows the user to add comments regarding the particular DIF occurrence being changed. And FIGS. 15-16 show a selection and assignment list subview, respectively, of a DIF assignment view. The use of the selection screen is to build up the assignment list. The actual assignment is done in the assignment list. That is, the user can build up a work list for the assignment via a more or less rough selection of locations or locations/products in the selection screen, and then decide the actual assignments in the assignment list. Other embodiments of DIF user interface 220 may provide additional display and functionality with respect to location groups.

Depending on the definition of a particular DIF according to this embodiment, assignment is possible to locations and products or to locations only. On level of product or location, it is possible to assign a DIF occurrence generically, i.e., to all products or all locations. As shown in FIG. 16, the selected objects (locations, products) are displayed in a grid with their number and language dependent short text. In case of generic assignment, an asterisk replaces the location or product number and the short text makes one aware of the generic assignment. The list can contain existing assignment records as well as new possible assignment records.

Lastly, FIG. 17 shows a DIF calendar, which displays the occurrence and/or value of DIFs and a particular object (location or location/product) over time. As shown in FIG. 17, several DIFs are assigned on product (and location) level and one location/product. In other embodiments, the calendar could display several DIFs assigned on location level and one location.

Several embodiments of the invention are specifically illustrated and/or described herein. However, it will be appreciated that modifications and variations of the invention are covered by the above teachings and within the purview of the appended claims without departing from the spirit and intended scope of the invention.

1. A computer-implemented method for managing demand influencing factors, comprising:
displaying through a user interface data representing occurrences of demand influencing factors for use in a forecast calculation;
receiving through the user interface an instruction to modify one or more of the demand influencing factor occurrences; and
applying the instructed modification to the data.

2. The method of claim 1, wherein the demand influencing factors include a promotion or advertising campaign.

3. The method of claim 1, wherein the demand influencing factors include a holiday or vacation.

4. The method of claim 1, wherein the demand influencing factors include a sports event.

5. The method of claim 1, wherein the demand influencing factors include a sales price or price change.

6. The method of claim 1, wherein the demand influencing factors include a weather condition.

7. The method of claim 1, wherein the instruction to modify includes an instruction to delete the one or more of the demand influencing factor occurrences.

8. The method of claim 1, wherein the instruction to modify includes an instruction to change an attribute of the one or more of the demand influencing factor occurrences.

9. The method of claim 8, wherein the attribute is a textual description of the one or more of the demand influencing factor occurrences.

10. The method of claim 8, wherein the attribute is a validity period of the one or more of the demand influencing factor occurrences.

11. The method of claim 1, wherein the instruction to modify includes an instruction to assign a location or product to the one or more of the demand influencing factor occurrences.

12. The method of claim 1, further comprising:
receiving through the user interface an instruction to create one or more demand influencing factor occurrences to the data; and
applying the instructed creation to the data.

13. The method of claim 12, wherein the application of the instructed creation to the data includes storing the created one or more demand influencing factor occurrences to the data in the data store.

14. The method of claim 1, further comprising:
receiving the data representing the occurrences of the demand influencing factors from an inbound interface from a data provider.

15. The method of claim 1, further comprising:
sending the data representing the occurrences of the demand influencing factors through an outbound interface to a forecasting engine.

16. The method of claim 1, wherein the application of the instructed modification to the data includes updating the modified one or more demand influencing factor occurrences to the data in the data store.

17. An apparatus for managing demand influencing factors, comprising:
a processor; and
a memory storing instructions adapted to be executed by said processor to:
display through a user interface data representing occurrences of demand influencing factors for use in a forecast calculation,
receive through the user interface an instruction to modify one or more of the demand influencing factor occurrences, and
apply the instructed modification to the data.

18. The apparatus of claim 17, wherein the instruction to modify includes an instruction to delete the one or more of the demand influencing factor occurrences.

19. The apparatus of claim 17, wherein the instruction to modify includes an instruction to change an attribute of the one or more of the demand influencing factor occurrences.

20. The apparatus of claim 17, wherein the instruction to modify includes an instruction to assign a location or product to the one or more of the demand influencing factor occurrences.

21. The apparatus of claim 17, further comprising instructions adapted to be executed by said processor to:
receive through the user interface an instruction to create one or more demand influencing factor occurrences to the data; and
apply the instructed creation to the data.

22. A system for managing demand influencing factors, comprising:
means for displaying through a user interface data representing occurrences of demand influencing factors for use in a forecast calculation;
means for receiving through the user interface an instruction to modify one or more of the demand influencing factor occurrences; and
means for applying the instructed modification to the data.

23. The system of claim 22, wherein the instruction to modify includes an instruction to delete the one or more of the demand influencing factor occurrences.

24. The system of claim 22, wherein the instruction to modify includes an instruction to change an attribute of the one or more of the demand influencing factor occurrences.

25. The system of claim 22, wherein the instruction to modify includes an instruction to assign a location or product to the one or more of the demand influencing factor occurrences.

26. The system of claim 22, further comprising:
means for receiving through the user interface an instruction to create one or more demand influencing factor occurrences to the data; and
means for applying the instructed creation to the data.
